(19) United States
(12) Patent Application Publication
(10) Pub. No.: US 2019/0032811 A1
(43) Pub. Date: Jan. 31, 2019

(54) DAMPED RELIEF VALVE USING DOUBLE PISTONS

(71) Applicant: PRATT & WHITNEY CANADA CORP., Longueuil (CA)

(72) Inventor: Roberto BRITO, Beloeil (CA)

(21) Appl. No.: 15/658,824

(22) Filed: Jul. 25, 2017

(51) Int. Cl. F16K 31/122; F16K 11/07; G05D 16/10; F01D 17/26

(52) U.S. Cl. CPC F16K 31/1221; F01D 17/26; G05D 16/106; F16K 11/07

(57) ABSTRACT

A gas turbine engine comprises bearing(s). A structure supporting the bearing defines a bearing cavity surrounding the at least one bearing, an ambient chamber and an intermediate chamber having a portion between the bearing cavity and the ambient chamber, with at least one wall forming a passage from the bearing cavity to the ambient chamber and through the portion of the intermediate chamber. A tube is received in the passage and having a first end open to the bearing cavity and a second end open to the ambient chamber, the second end adapted to be connected to a conduit for fluid communication between the bearing cavity and the through the tube, wherein a portion of or near the first end of the tube is sealingly joined to the at least one wall, and the second end of the tube contacts the at least one wall and is free to move relative to the at least one wall.

### TECHNICAL FIELD

The present disclosure pertains to hydraulic damping valves, such as a cold start valve used in a gas turbine engine.

### BACKGROUND OF THE ART

Oil valves are used in hydraulic systems to relieve hydraulic pressures. For example, an oil valve known as a cold start valve is used in typical engines to help relieve the oil pressure during cold star conditions. Indeed, when a high-viscosity fluid such as oil is pumped through the engine passages, the pressure builds up and the cold start valve opens to relieve the pressure. The cold start valve will bypass the flow until the system pressure is reduced to a set cracking pressure. The cold start valve may assist in preventing over pressurizing of engine components. During the cold start valve operation, the action of the cold start valve may result in sustained oscillations, defined as valve instability. Valve instability may result in oil pressure fluctuations.

### SUMMARY

In accordance with a first embodiment of the present disclosure, there is provided a damping valve comprising a tubular body having at least one inlet and at least one outlet, a damping piston in the tubular body, the damping piston moveable between a closed position in which the outlet is substantially blocked, and a bypass position in which fluid flow from the inlet to the outlet is permitted, a damping biasing device biasing the damping piston toward the closed position, the damping piston having a first effective piston area in a first chamber exposed to fluid pressure at the inlet and a second effective piston area in a second chamber, the second effective piston area being smaller than the first effective piston area, at least one fluid passage formed in the damping valve for fluid communication between the first chamber and the second chamber to direct fluid from the inlet to the second chamber, whereby fluid in the second chamber applies a force concurrent to the biasing of the damping biasing device and assists in displacing the damping piston to the closed position.

In accordance with a second embodiment of the present disclosure, there is provided a hydraulic system of a gas turbine engine comprising: a hydraulic circuit configured for receiving a fluid and for feeding the fluid to at least one component of the gas turbine engine; and an oil valve comprising a tubular body having at least one inlet connected to the hydraulic circuit and at least one outlet, a damping piston operatively positioned in the tubular body, the damping piston configured for being exposed to the fluid of the inlet, and for being displaced between a closed position in which the damping piston blocks the outlet, and a bypass position in which the damping piston allows fluid flow from the inlet to the outlet, a damping biasing device to apply a biasing force against the damping piston and toward the closed position, the damping piston having a first side in a first chamber exposed to fluid of the inlet to apply a force against the biasing force of the damping biasing device, the damping piston having a second side in a second chamber and having an effective area smaller than that of the first side, at least one fluid passage formed in the oil valve for fluid communication between the first chamber and the second chamber to expose the second side of the damping piston to the fluid of the inlet, whereby fluid in the second chamber applies a force concurrent to the biasing force of the damping biasing device and assists in displacing the damping piston to the closed position.

In accordance with a third embodiment of the present disclosure, there is provided a method for damping fluid pressure in a hydraulic circuit comprising: exposing a damping valve to a fluid in the hydraulic circuit; biasing a damping piston with a damping biasing force such that the damping piston closes a fluid outlet; allowing the fluid to fill a first chamber and a second chamber on opposite sides of the damping piston of the damping valve; and displacing the damping piston away from closing the fluid outlet when a force resulting from fluid pressure on the damping piston in the first chamber exceeds a combination of a force from fluid pressure on the damping piston in the second chamber and of the damping biasing force.

### DESCRIPTION OF THE DRAWINGS

Reference is now made to the accompanying figures in which:

FIG. 1 is a schematic cross-sectional view of a gas turbine engine;

FIG. 2 is a cross-sectional view of a damping valve in accordance with the present disclosure, with a damping piston in a closed position;

FIG. 3 is a cross-sectional view of the damping valve of FIG. 2, with the damping piston in a bypass position; and

FIG. 4 is a cross-sectional view of the damping valve of FIG. 2, with a relief piston in a relief position.

### DETAILED DESCRIPTION

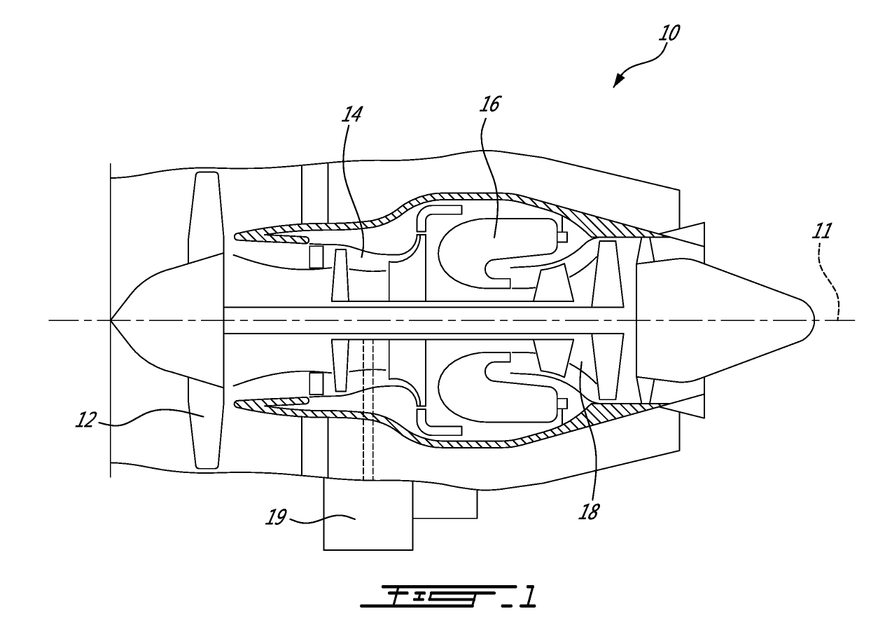

FIG. 1 illustrates a turbofan gas turbine engine 10 of a type preferably provided for use in subsonic flight, generally comprising in serial flow communication a fan 12 through which ambient air is propelled, a multistage compressor 14 for pressurizing the air, a combustor 16 in which the compressed air is mixed with fuel and ignited for generating an annular stream of hot combustion gases, and a turbine section 18 for extracting energy from the combustion gases. An accessory gearbox 19 may be driven by either one of the compressor 14 and the turbine section 18. In numerous locations of the gas turbine engine 10, bearings support rotating components, such as the turbine shaft, the compressor shaft, and gears and shafts of the gearbox. A hydraulic system, including a hydraulic circuit is connected to some of the engine components of the gas turbine engine 10, to provide a fluid such as oil, used for different purposes (e.g., lubricating, cooling, etc).

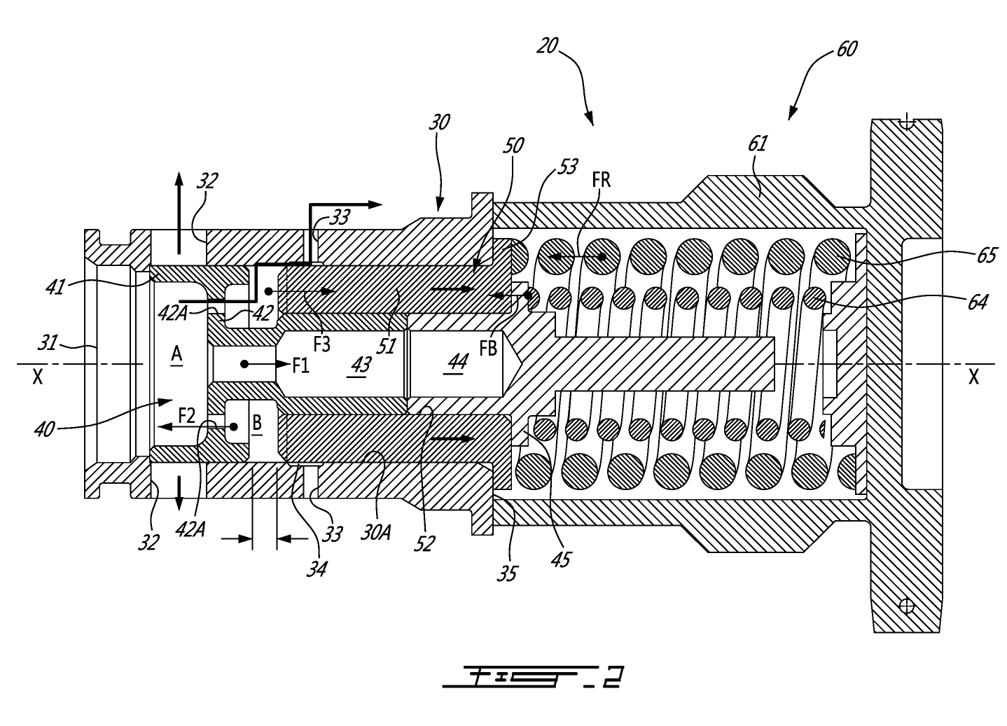

Referring to FIGS. 2-4, an oil valve in accordance with the present disclosure is generally shown at 20. The valve 20 is described interchangeably herein as oil valve, a damping valve, a damped relief valve with double pistons, etc. The damping valve 20 may be used in a hydraulic system, for instance in an engine such as the gas turbine engine 10. The damping valve 20 may generally be defined as having some or all of the following components:
A tubular body 30 forming a structure of the oil valve 20, and by which the oil valve 20 is connected to a hydraulic circuit.
A damping piston 40 operatively received in the tubular body 30 and displaceable to perform a damping function, i.e., a gradual relief of fluid pressure. The damping piston 40 may therefore be referred to as a relief piston. However, for consistency and to distinguish the piston 40 from another relief piston (50), in spite of the fact that the piston 40 is a relief piston, the expression uses herein will be “damping piston”.
A relief piston 50 operatively received in the tubular body 30 and displaceable to perform a pressure-relief function.
A biasing assembly 60 biasing the damping piston 40 and the relief piston 50 while the pistons 40 and 50 respectively perform their damping function and pressure-relief function.

The tubular body 30 defines an inner cavity 30A having a longitudinal axis X and being open at opposed ends, including at an inlet 31. The tubular body 30 is connected to the hydraulic circuit at the inlet 31, so as to expose a portion of its inner cavity 30A to a fluid pressure from the hydraulic circuit. For example, the tubular body 30 may have at the inlet 31 appropriate connection means, such as threading, welding, brazing, for connection to the hydraulic circuit. The tubular body 30 is shown as having a nipple shape, i.e., a straight tube, but may also be shaped as an elbow, a tee (with two inlets), etc. The cross-sectional shape of the inner cavity 30A is not visible, but may be circular, oval, etc.

One or more outlets 32 may be defined in a wall of the tubular body 30. In FIGS. 2-4, the tubular body 30 is shown as having at least a pair of diametrically opposed outlets 32, although more or fewer outlets 32 may be present. The outlets 32 are radially oriented relative to the longitudinal axis X, but other orientations are contemplated. In an embodiment, the outlet(s) 32 is(are) in fluid communication with a scavenging portion of the hydraulic system, but the outlet(s) 32 may be connected to other parts of the gas turbine engine 10.

One or more relief passages 33 may also be defined in the wall of the tubular body 30. In FIGS. 2-4, the tubular body 30 is shown as having at least a pair of diametrically opposed relief passages 33, although more or fewer relief passages 33 may be present. The relief passages 33 may be related by an annular channel 34 formed into the inner cavity 30A of the tubular body 30. The relief passages 33 may be radially oriented relative to the longitudinal axis X as in FIGS. 2-4, but other orientations are contemplated. In an embodiment, the relief passage(s) 33 is(are) in fluid communication with a scavenging portion of the hydraulic system, but the passage(s) 33 may be connected to other parts of the gas turbine engine 10. The end of the tubular body 30 away from the inlet 31 may define a surface used as an abutment, and hence referred to as abutment surface 35. As detailed hereinafter, the abutment surface 35 may be used to limit movement of the relief piston 50 toward the inlet 31 as a result of a relief biasing force from the biasing assembly 60.

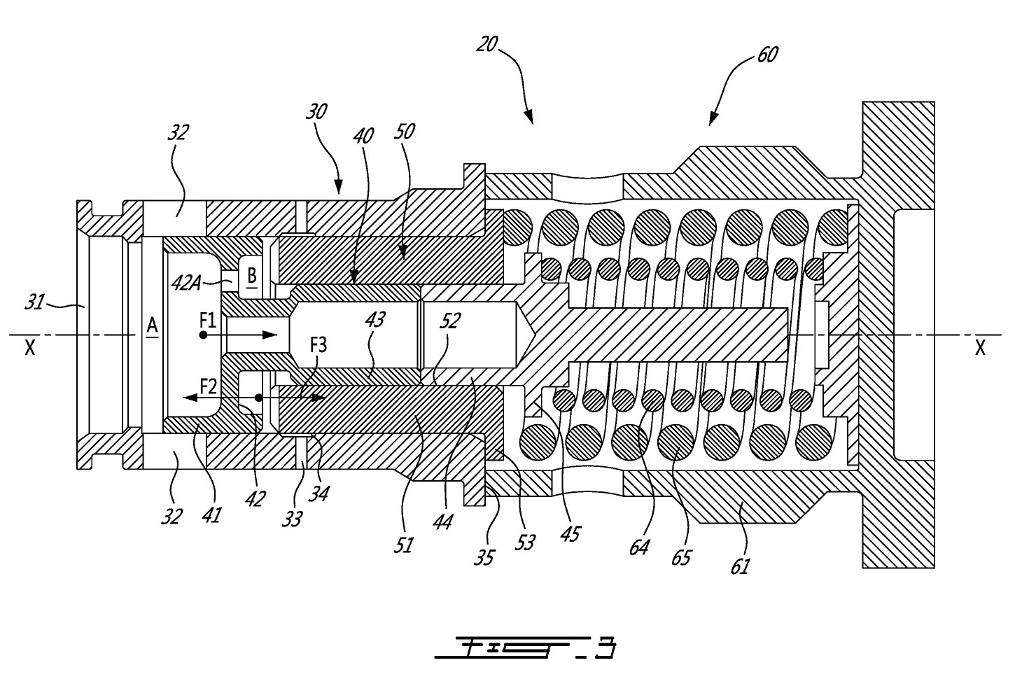

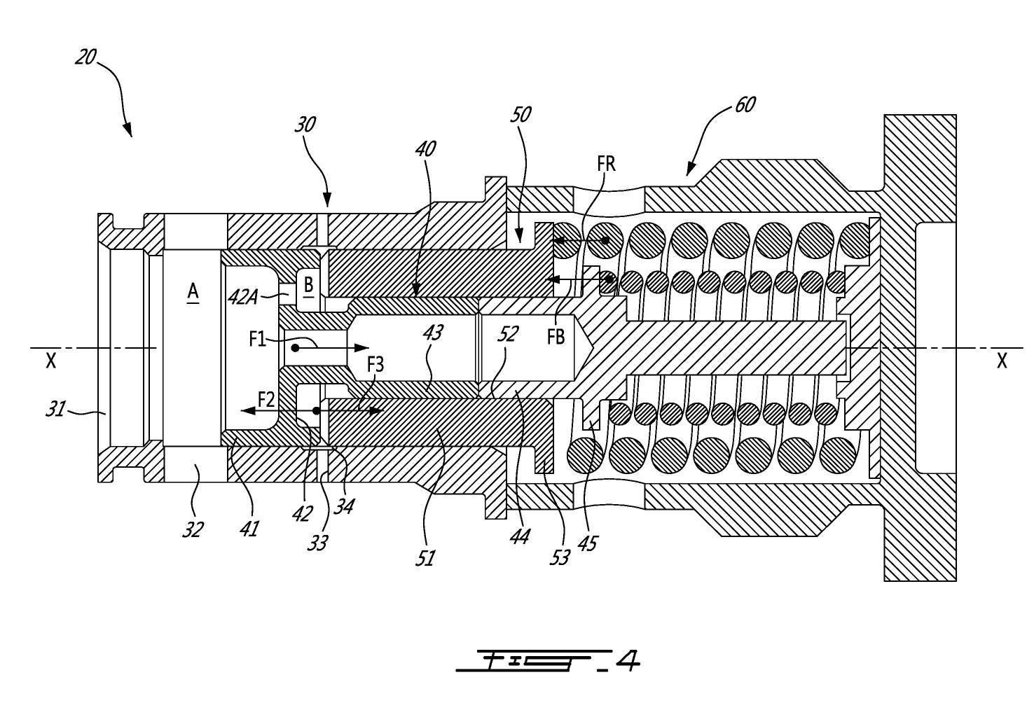

The damping piston 40 is operatively received in the tubular body 30, so as to be displaceable between a closed position, as in FIG. 2, and a bypass position, shown in both FIGS. 3 and 4. The movement between positions is gradual, as opposed to be a binary on/off, to create a damping effect. The damping effect is caused by the variation of the damping piston 40's position relative to the tubular body 30, causing in a variation of size of a damping path, concurrently formed by the alignment of the damping piston 40 with the outlet(s) 32 in the tubular body 30.

The damping piston 40 may have different configurations, one of which is shown in FIGS. 2-4. In this embodiment, the damping piston 30 has a circumferential wall 41 that conforms to a surface of the inner cavity 30A of the tubular body 30, such that the circumferential wall 41 and the tubular body 30 are in a substantially sealed engagement. Although not shown, seals may be provided, for instance in the circumferential wall 41, to block fluid passage between the surface of the inner cavity of the tubular body 30 and the circumferential wall 41. The circumferential wall 41 may be long enough, in the axial direction (i.e., along the longitudinal axis X), to fully block the outlet(s) 32 in the closed position of the damping piston 40, as in FIG. 2.

The damping piston 40 may further include an axial wall 42 radially inwardly of the circumferential wall 41, in such a way that the damping valve 20 is separated in a first chamber A and a second chamber B, namely on opposite sides of the axial wall 42. The axial wall 42 has radially extending surfaces, as does the circumferential wall 41, such that fluid pressure in the first chamber A will result in a force vector F1 in the right direction of FIGS. 2-4. The axial wall 42 further defines one or more fluid passages 42A through which fluid may flow from the first chamber A to the second chamber B and vice-versa, such that there may result a fluid pressure build up in the second chamber B. Accordingly, as the axial wall 42 has radially extending surfaces facing the second chamber B, as does the circumferential wall 41, fluid pressure in the second chamber B will result in a force vector F2 in the left direction of FIGS. 2-4. Also, fluid pressure in the second chamber B may exert a force F3 against the relief piston 50.

As an alternative configuration, the damping piston 40 may not have the circumferential wall 41, but have instead a thicker version of the axial wall 42, for the axial wall 42 to block the outlet(s) 32 in the closed position of the damping piston 40. As yet another alternative or supplemental configuration, the one or more fluid passages 42A may be formed in the tubular body 30 instead of in the damping piston 40. Tubing and/or pipes may also be used to create the fluid communication between the chambers A and B. The number and the size of the fluid passage(s) 42 to control the flow of fluid between chambers A and B, and takes into account the pressure of operation of the hydraulic system, the set cracking pressure, the desired damping effect, and/or the biasing force, etc.

A plunger 43 extends from the axial wall 42, and extends axially along the longitudinal axis X. The plunger 43 may for instance be hollow, but may also be solid. A plunger extension 44 is connected to an end of the plunger 43, and is the part of the damping piston 40 that is connected to the biasing assembly 60. In an embodiment, the plunger 43 and the plunger extension 44 are a single monoblock piece (resulting in an integral plunger 43), and may also be monoblock with circumferential wall 41 and the axial wall 42. Other arrangements are contemplated as well. The plunger 43 and plunger extension 44 are slidingly received in the relief piston 50, in such a way that the damping piston 40 may translate in the axial direction, i.e., in a direction parallel to the longitudinal axis X. Hence, the relief piston 50 serves as a support for the damping piston 40. A flange 45 may be provided at the end of the plunger extension 44 (or plunger 43 if no extension is present), and serves as interface between the damping piston 40 and the biasing assembly 60. The flange 45 is one possible configuration, with others including a receptacle for spring in the plunger 43 or plunger extension 44. The flange 45 may also act as an abutment coming into contact with the relief piston 50, to set the closed position of the damping piston 40, relative to the tubular body 30.

The effective piston area (a.k.a., effective area) of the damping piston 40 in the first chamber A is greater than the effective piston area of the damping piston 40 in the second chamber B. Stated differently, the total surface of the damping piston 40 that will convert fluid pressure in chamber A to force F1 is greater than the total surface of the damping piston 40 that will convert fluid pressure in chamber B to force F2. Therefore, for an equal fluid pressure in chambers A and B, as leveled out by the fluid passage(s) 42, force F1 will be greater than force F2. A biasing force FB, exerted by the biasing assembly 60 is concurrent with force F2 and will consequently be opposed to force F1.

The relief piston 50 is operatively received in the tubular body 30 and is axially offset from the axial wall 42 of the damping piston 40. The relief piston 50 is displaceable between a closed position, as in FIGS. 2 and 3, and a relief position, shown in both FIG. 4. The relief piston 50 may have different configurations, one of which is shown in FIGS. 2-4. In this embodiment, the relief piston 50 has an annular body 51 that conforms to a surface of the inner cavity 30A of the tubular body 30, such that a peripheral wall of the annular body 51 and the tubular body 30 are in a substantially sealed engagement. Although not shown, seals may be provided, for instance in the peripheral wall of the annular body 51, to block fluid passage between the surface of the inner cavity of the tubular body 30 and the annular body 51. The wall of the annular body 51 is long enough, in the axial direction (i.e., along the longitudinal axis X), to fully block the relief passage(s) 33 and the annular channel 34 if present, in the closed position of the relief piston 50, as in FIGS. 2 and 3.

The annular body 51 defines an inner channel 52 in which the plunger 43 and plunger extension 44 of the damping piston 40 are slidingly received, consequently forming a sliding joint. The annular body 51 may also have a flange 53, or similar abutment surface (e.g., tab), to delimit its closed position relative to the tubular body 30. The flange 53 may also be the interface of the relief piston 50 with the basing assembly 60, although other configurations are possible as well.

The biasing assembly 60 is shown as having its own casing 61 that is connected to the tubular body 30 Other arrangements are possible as well, to provide a structure for components of the biasing assembly 60 to exert biasing forces against the damping piston 40 and the relief piston 50. The casing 61 may be equipped with connection means to be connected to a surrounding structure, if necessary. The biasing assembly 60 may have a damping biasing device 64. The damping biasing device 64 may be a compression coil spring, although other types of biasing devices may be used, such as leaf springs, hydraulic/pneumatic cylinders, etc. The damping biasing device 64 exerts force FB on the damping piston 40, to bias the damping piston 40 toward the closed position of FIG. 2. The biasing assembly 60 may also have a relief biasing device 65. The relief biasing device 65 may also be a compression coil spring, although other types of biasing devices may be used, such as leaf springs, hydraulic/pneumatic cylinders, etc. The relief biasing device 65 exerts force FR on the relief piston 50, to bias the relief piston 50 toward the closed position of FIGS. 2 and 3. As observed from FIGS. 2-4, the biasing devices 64 and 65 are independent from one another in applying their respective forces FB and FR. The damping piston 40 is only opposed the force FB if it moves away from the closed position of FIG. 2. Likewise, the relief piston 40 is only opposed the force FR if it moves away from the closed position of FIGS. 2 and 3. Even though there is an abutment between the flange 45 of the damping piston 40 and the annular body 51 of the relief piston 50, as in FIG. 2, a sequence of operation of the damping valve 40 will have the damping piston 40 move to its bypass position as in FIG. 3, for the relief piston 50 to then be movable to the relief position of FIG. 4. To achieve this arrangement, the biasing force FR produced by the biasing device 65 may be greater than the biasing force FB produced by the biasing device 64. Moreover, as FB and F2 concurrently oppose to F1, the biasing force FB produced by the biasing device 64 may be lesser than an arrangement without the second chamber B and without F2.

In an embodiment, the current disclosure therefore describes a double-piston valve configuration which allows more gradual damping at various oil viscosity conditions. Damping is achieved by using the chambers A and B, with the calibrated passage(s) 42A, and hence use fluid pressure in the second chamber B to counter the fluid pressure in the first chamber A, to allow the usage of lower spring rate (lb/inch). As a consequence, pressure fluctuations in the hydraulic system employing the valve 20. The relief piston 50 is provided in case the maximum pressure of the system is reached.

The damping valve 20 may be used as a cold start valve. In such a case, in cold conditions and with resulting high oil viscosity, the valve 20 is open as in FIG. 3, in the bypass position of the damping piston 40. For this condition, no pressure balance is achieved since oil pressure—affected by oil viscosity—is higher than the spring reacting pressure, and thus of force FB. During oil warm-up and with gradual reduced oil viscosity, the valve 20 will gradually move toward the closed position of FIG. 2, to balance the pressure. Pressure balance is achieved between chambers A and B by the fluid passage(s) 42A. Constrained fluid flow through the fluid passage(s) 42A and between chambers A and B will cause damping to reduce oscillations of the damping piston and avoid system pressure fluctuations. Spring reacting force (lb/inch) is self-adjusted to balance the fluid pressure in the hydraulic system. Therefore, due to the assistance of fluid pressure via F2, a lower spring rate is used to reduce reacting forces of the biasing device 64, and thus enhancing the damping effect. During normal engine operation, the damping valve 20 is closed. Pressure balance is achieved for this condition when calibrated pressure differential between the chambers A and B in addition to damping biasing force FB is greater than the fluid pressure in the hydraulic system. The damping valve 20 may therefore dampen fluid pressure in a hydraulic circuit by being exposed to a fluid in the hydraulic circuit. The damping valve 20 biases the damping piston 40 with damping biasing force FB such that the damping piston closes the fluid outlet(s) 32. The valve 20 allows the fluid to fill the first chamber A and the second chamber B on opposite sides of the damping piston 40. The valve 20 may displaces the damping piston 40 away from closing the fluid outlet(s) 32 when force F1 resulting from fluid pressure on the damping piston 40 in the first chamber A exceeds a combination of force F2 from fluid pressure on the damping piston 40 in the second chamber B and of the damping biasing force FB. The valve 20 may expose its relief piston 50 to fluid in the second chamber B, and may bias the relief piston 50 with the relief biasing force FR such that the relief piston 50 closes the relief passage(s) 33. The valve 20 may displace the relied piston 50 away from closing the relief passage(s) 33 when force F3 from fluid pressure on the relief piston 50 in the second chamber B exceeds the relief biasing force FR.

The above description is meant to be exemplary only, and one skilled in the art will recognize that changes may be made to the embodiments described without departing from the scope of the invention disclosed. For example, while the valve 20 is described as having a pair of pistons 40 and 50, there may be a configuration of the valve 20 with only the damping piston 40, i.e., without the relief piston 50 and associated biasing device 65. In such a case, the damping piston 40 would be slidingly mounted to the tubular body 30, and with the second chamber B axially bound by a wall instead of by the relief piston 50. Still other modifications which fall within the scope of the present invention will be apparent to those skilled in the art, in light of a review of this disclosure, and such modifications are intended to fall within the appended claims.

1. A damping valve comprising a tubular body having at least one inlet and at least one outlet, a damping piston in the tubular body, the damping piston moveable between a closed position in which the outlet is substantially blocked, and a bypass position in which fluid flow from the inlet to the outlet is permitted, a damping biasing device biasing the damping piston toward the closed position, the damping piston having a first effective piston area in a first chamber exposed to fluid pressure at the inlet and a second effective piston area in a second chamber, the second effective piston area being smaller than the first effective piston area, at least one fluid passage formed in the damping valve for fluid communication between the first chamber and the second chamber to direct fluid from the inlet to the second chamber, whereby fluid in the second chamber applies a force concurrent to the biasing of the damping biasing device and assists in displacing the damping piston to the closed position.

2. The damping valve according to claim 1, wherein the at least one fluid passage is through the damping piston.

3. The damping valve according to claim 2, wherein the outlet is radially oriented in the tubular body, and the damping piston moves axially in the tubular body.

4. The damping valve according to claim 1, further comprising a relief passage in fluid communication with the second chamber.

5. The damping valve according to claim 4, wherein the relief passage has an annular groove defined in the tubular body.

6. The damping valve according to claim 4, wherein the relief passage is radially oriented in the tubular body, and the relief piston moves axially in the tubular body.

7. The damping valve according to claim 4, further comprising a relief piston operatively positioned in the tubular body, the relief piston configured for being exposed to the fluid of the second chamber, and for being displaced between a closed position in which the relief piston blocks the relief passage, and a relief position in which the relief piston allows fluid flow from the second chamber to the relief passage, a relief biasing device apply a biasing force against the relief piston and toward the closed position of the relief piston.

8. The damping valve according to claim 7, wherein the damping piston is slidingly connected to the relief piston to be displaceable between its closed position and bypass position.

9. The damping valve according to claim 8, wherein the damping piston and the relief piston are concentrically positioned in the tubular body.

10. The damping valve according to claim 8, further comprising complementary abutment surfaces between the damping piston, the relief piston and the tubular body to limit movements of the damping piston and of the relief piston.

11. A hydraulic system of a gas turbine engine comprising:
a hydraulic circuit configured for receiving a fluid and for feeding the fluid to at least one component of the gas turbine engine; and
an oil valve comprising a tubular body having at least one inlet connected to the hydraulic circuit and at least one outlet, a damping piston operatively positioned in the tubular body, the damping piston configured for being exposed to the fluid of the inlet, and for being displaced between a closed position in which the damping piston blocks the outlet, and a bypass position in which the damping piston allows fluid flow from the inlet to the outlet, a damping biasing device to apply a biasing force against the damping piston and toward the closed position, the damping piston having a first side in a first chamber exposed to fluid of the inlet to apply a force against the biasing force of the damping biasing device, the damping piston having a second side in a second chamber and having an effective area smaller than that of the first side, at least one fluid passage formed in the oil valve for fluid communication between the first chamber and the second chamber to expose the second side of the damping piston to the fluid of the inlet, whereby fluid in the second chamber applies a force concurrent to the biasing force of the damping biasing device and assists in displacing the damping piston to the closed position.

12. The hydraulic system according to claim 11, wherein the at least one fluid passage is through the damping piston.

13. The hydraulic system according to claim 11, further comprising a relief passage in fluid communication with the second chamber.

14. The hydraulic system according to claim 13, further comprising a relief piston operatively positioned in the tubular body, the relief piston configured for being exposed to the fluid of the second chamber, and for being displaced between a closed position in which the relief piston blocks the relief passage, and a relief position in which the relief piston allows fluid flow from the second chamber to the relief passage, a relief biasing device apply a biasing force against the relief piston and toward the closed position of the relief piston.

15. The hydraulic system according to claim 14, wherein the damping piston is slidingly connected to the relief piston to be displaceable between its closed position and bypass position.

16. The hydraulic system according to claim 15, wherein the damping piston and the relief piston are concentrically positioned in the tubular body.

17. The hydraulic system according to claim 15, further comprising complementary abutment surfaces between the damping piston, the relief piston and the tubular body to limit movements of the damping piston and of the relief piston.

18. A method for damping fluid pressure in a hydraulic circuit comprising:
exposing a damping valve to a fluid in the hydraulic circuit;
biasing a damping piston with a damping biasing force such that the damping piston closes a fluid outlet;
allowing the fluid to fill a first chamber and a second chamber on opposite sides of the damping piston of the damping valve; and
displacing the damping piston away from closing the fluid outlet when a force resulting from fluid pressure on the damping piston in the first chamber exceeds a combination of a force from fluid pressure on the damping piston in the second chamber and of the damping biasing force.

19. The method according to claim 18, further comprising:
exposing a relief piston to fluid in the second chamber;
biasing a relief piston with a relief biasing force such that the relief piston closes a relief passage; and
displacing the relied piston away from closing the relief passage when a force from fluid pressure on the relief piston in the second chamber exceeds the relief biasing force.

20. The method according to claim 19, wherein displacing the damping piston away from closing comprises slidingly displacing the damping piston in the relief piston.
